(19) United States
(12) Patent Application Publication
(10) Pub. No.: US 2009/0280214 A1
(43) Pub. Date: Nov. 12, 2009

(54) ARTIFICIAL INTELLIGENCE APPARATUS FOR MAKING FROZEN YOGURT AND METHOD FOR CONTROLLING

(75) Inventors: Jong Boo Kim, Daegu (KR); Bong Soon Kwak, Daegu (KR); Bong Sool Kim, Busan (KR); Kyung Ho Kim, Daegu (KR)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: NUC Electronics Co., Ltd., Daegu (KR)

(21) Appl. No.: 12/297,172

(22) PCT Filed: Apr. 6, 2007
(86) PCT No.: PCT/KR2007/001702

§ 371 Date: Oct. 14, 2008

(30) Foreign Application Priority Data
Apr. 14, 2006 (KR) 10-2006-0034011

(51) Int. Cl. A23G 9/22; A23G 9/04; A23C 9/12; A23L 3/36; A23L 1/025

(52) U.S. Cl. 426/34; 426/519; 99/470; 99/348

(57) ABSTRACT

An apparatus includes a housing, a heat conductive container for receiving yogurt ingredients, a heating unit installed in the housing and provided with a heating element for heating the container, a cooling unit installed in the housing and provided with a refrigerant pipe for cooling the container by a refrigeration cycle caused by supplying electric power, a stirring unit provided with a stirring blade which is driven by a motor to be rotated in the container, and a control unit configured to selectively control the heating unit, the cooling unit and the stirring unit to make frozen yogurt of the yogurt ingredients. A method includes steps for preparing frozen yogurt using the apparatus, wherein the frozen yogurt is fermented, ripened and frozen under control of the control unit within a single container, for example. In alternative examples, other fermented yogurt and non-fermented ice cream or sherbet products are made using the same apparatus.

### FIELD OF INVENTION

The field relates to an apparatus for making frozen yogurt, and more particularly, an apparatus for making frozen yogurt and a method for controlling the apparatus for fermenting and-preparing frozen fermented yogurt ingredients in the same container.

### BACKGROUND

Yogurt, which is obtained by fermenting milk and the like with lactobacilli, has been prevailingly popularized as a health food since yogurt is superior to milk in ingestibility and contains lactobacilli which may lower the activity in the intestine of harmful bacteria and/or reduce harmful bacteria.

Conventionally, yogurt has been made and sold by the manufacturers of dairy products or drinks in large quantities. Therefore, there are problems in that the yogurt purchased from makers may often include unwanted ingredients (for example, carrots etc.) which a consumer dislikes and the costs for purchasing the yogurt are somewhat large.

An apparatus for making yogurt is disclosed in Korean Utility Model Registration No. 20-2470006 which was filed by the present applicant and issued. The disclosed apparatus for making yogurt is configured to make yogurt by performing a heating process for yogurt ingredients received in a reception container under the predetermined fermentation temperature. This apparatus for making yogurt can make no other kind of yogurt except gelled plain yogurt.

Disclosed in U.S. Pat. No. 5,829,344 is an apparatus for making frozen yogurt using a cooling container in which a refrigerant is provided. In the disclosed apparatus, after a container, which is optionally provided in the apparatus and in which a refrigerant is provided, is cooled in a freezing chamber of a freezer in advance, soft frozen yogurt is made by putting yogurt into the container and using a stirring unit provided in the apparatus itself. However, there are problems in that the conventional apparatus necessarily requires a cumbersome process in which the container should be loaded into and unloaded from the freezing chamber to make the frozen yogurt. In addition, there are problems in that the universality of the container can lowers since the container is used only for making soft frozen yogurt.

### SUMMARY OF THE INVENTION

An apparatus for making frozen yogurt and a method for controlling the apparatus comprises fermenting ingredients in a container and then processing the resulting yogurt using refrigerating and/or freezing of the fermented yogurt ingredients in the same container to make frozen yogurt.

An apparatus for making frozen yogurt comprises a housing; a heat conductive container for receiving yogurt ingredients; a heating unit installed in the housing and provided with a heating element for heating the container; a cooling unit installed in the housing and provided with a refrigerant pipe for cooling the container by a refrigeration cycle caused by supplying electric power; a stirring unit provided with a stirring blade which is driven by a motor to be rotated in the container; and a control unit configured to selectively control the heating unit, the cooling unit and the stirring unit to make frozen yogurt of the yogurt ingredients, for example.

A method for controlling an apparatus for making frozen yogurt comprises providing an, apparatus comprising a housing, a heat conductive container for receiving yogurt ingredients, a heating unit installed in the housing and provided with a heating element for heating the container, a cooling unit installed in the housing and provided with a refrigerant pipe for cooling the container by a refrigeration cycle caused by supplying electric power, a stirring unit provided with a stirring blade which is driven by a motor to be rotated in the container, and a control unit configured to selectively control the heating unit, the cooling unit and the stirring unit; heating the yogurt ingredients in the heat conductive container to obtain fermented yogurt using of the heating unit controlled by the control unit; and freezing the fermented yogurt in the housing using the cooling unit controlled by the control unit, while controlling the stirring blade of the stirring unit.

According to one example a fermenting process, a refrigeration-ripening process and/or a freezing process for the yogurt ingredients is sequentially performed in one container, allowing highly nutritious and beneficial frozen yogurt to be made at home in a one-pot process. For example, ice cream frozen yogurt or sherbet frozen yogurt may be easily made by selectively stirring the yogurt ingredients in fermenting, ripening and freezing processes. In one example, an The apparatus makes it possible not only to make frozen yogurt, but also to make gelled plain or liquidized yogurt, which is fermented and then sufficiently ripened, without using a conventional refrigerator. The method for using the apparatus makes the end product, such as a yogurt drink, gelled yogurt or frozen yogurt, selectable by the user of the apparatus.

In another example, a method makes unfermented ice cream or refrigerates and stores yogurt using at least one of a heating unit, a cooling unit and a stirring unit, which are provided in the apparatus itself.

### BRIEF DESCRIPTION OF THE DRAWINGS

FIG. 1 is a partial sectional perspective view showing an example of an apparatus for making frozen yogurt;

FIG. 2 is a partial cross sectional view showing features of an apparatus for making frozen yogurt, schematically.

FIG. 3 is a diagram illustrating coupling of a control unit to a refrigeration unit, a heating unit, and stirring unit.

FIGS. 4A-4C illustrates three alternative examples of a cup for containing container.

FIGS. 5A-5D illustrate additional examples a cup for containing a container.

FIG. 6 is a perspective view showing an apparatus for making frozen yogurt having a stirring unit hinged to a housing;

FIG. 7 is a block diagram illustrating a controlling method of an apparatus for making frozen yogurt.

### DETAILED DESCRIPTION

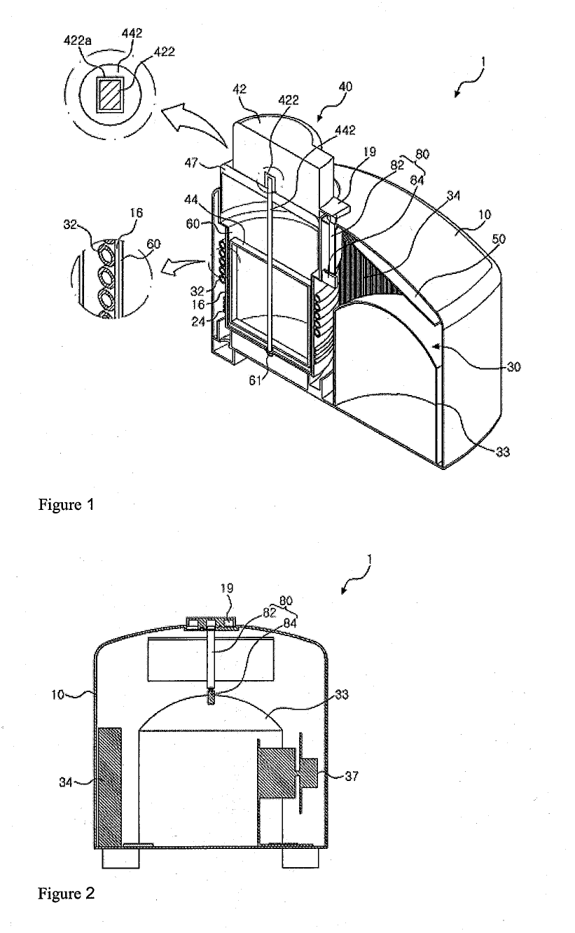

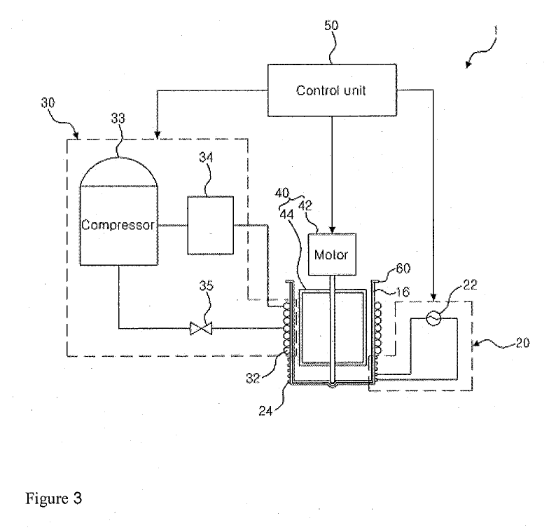

FIGS. 1-3 show an example of an apparatus for making frozen yogurt. Referring to FIG. 3, an apparatus 1 for making frozen yogurt includes a control unit 50 electrically coupled to a heating unit 20, a cooling unit 30, and a stirring unit 40. The apparatus 1 for making frozen yogurt further includes a heat conductive container 60 that is removable for receiving yogurt ingredients. The heating unit 20, the cooling unit 30 and the control unit 50 are installed in a housing 10, such as illustrated in FIG. 1. The stirring unit 40 may be configured to be detachably mounted atop the housing 10. For example, as illustrated in FIG. 6, a stirring unit 40 may be hingeably attached to the housing 10.

Referring to FIG. 1, a metallic heat conductive cup 16 for detachably receiving the heat conductive container 60 is fixed and installed within the housing 10. The top of the housing 10 above the heat conductive cup 16 may be open and in the shape of a circle, so that a heat conductive container 60 may be inserted and removed from the open portion. A stirring unit 40 may be attached to or detached from an operating position atop the housing 10.

A heat conductive cup 16 and a heat conductive container 60 received within the cup 16 are matingly engaged, and the heat conductive container 60 may be brought into contact with and received in an internal peripheral surface of the heat conductive cup 16. The heat conductive cup 16 serves to transfer heat to the refrigerating coils 32 or from the heating unit 20. Thus, the yogurt ingredients may be heated or cooled by the heat conductive container 60. To this end, an external surface of the heat conductive cup 16 may be in contact with a refrigerant pipe 32 of the cooling unit 30 and heating element 24 of the heating unit 20, such as a hot wire type element.

The refrigerant pipe 32, which is a pipe for allowing Freon, ammonia or other refrigerants to flow there through may comprise a cooling unit 30 together with a compressor 33, a condenser (or radiator) 34, an expansion valve 35, and the like as illustrated in FIG. 2, for example. A radiating fan 37 may be used for assisting the function of the condenser 34.

Referring again to FIG. 1 and FIGS. 4A-4C and 5A-5D, the refrigerant pipe 32 is wound in the form of a coil around the external peripheral surface of the heat conductive cup 16. As such, the refrigerating cycle performed by power application may cause the cooling unit 30 to transfer heat to the coil 32 at a temperature of about the refrigerating of 2 to 5° C. or at a freezing temperature of about −20° C. The refrigerating unit at 2 to 5° may be used to refrigeration-ripen fermenting yogurt, while the freezing unit at −20° C. may be used to freeze the yogurt ingredients, which have completely the fermenting process and/or the ripening process after the fermenting process.

The heating element 24, which constitutes the heating unit 20 together with an electric power supply 22 and the like, is wound around a lower portion of the external peripheral surface of the heat conductive cup 16 at a distance from the refrigerant pipe 32, for example. The heating function of the heating unit 20 including the heating element 24 allows the yogurt ingredients in the heat conductive container 60 to be heated to a fermentation temperature such as a range of 40 to 42° C., or an optimum temperature range for growing lactobacilli to perform the fermenting process, for example.

A heating temperature of the heating element 24 may be determined to be equal to or higher than the aforementioned fermentation temperature range in consideration of any heat loss. If a temperature of the heating element 24 is too high, it may influence negatively the refrigerant which flows through the refrigerant pipe 32 and may even cause an explosion of the refrigerant pipe 32. A temperature of the heating element 24 may be limited to less than about 60° C., for example.

The difference between the temperature of the heating element 24 and the optimal fermentation temperature range of the yogurt ingredients may depend on a variety of factors, such as a thickness, a shape and a material of the heat conductive container 60 and the heat conductive cup 16, a gap there between, or the like. The heat conductive container 60 and the heat conductive cup 16 may be designed in consideration of these factors such that the aforementioned temperature difference is predetermined to be within an acceptable range, for example. Also, the stirring unit 40 and cooling unit 30 may be used to make non-fermented ice cream.

A stirring unit 40 is used to make frozen yogurt by stirring gelled yogurt in a freezing process using of the cooling unit 30 or to make sherbet frozen yogurt by stirring fermented, liquidized yogurt in a freezing process using the cooling unit 30.

Fermented yogurt may be obtained by the cohesion of the yogurt ingredients during a fermenting process and/or a refrigeration-ripening process after the fermenting process. A gelled yogurt is generally referred to as a plain yogurt if no flavorings are added. A liquid yogurt may be obtained by intermittently stirring the yogurt ingredients during a fermenting process and/or a or the refrigeration-ripening process to prevent the yogurt ingredients from gelling . The stirring unit 40 may be used to prevent the yogurt ingredients from being gelled forming liquid yogurt during the fermenting and/or refrigerating process, as well as used in the freezing process for preparing frozen yogurt or a frozen yogurt sherbet.

The stirring unit 40 includes a motor 42 and a stirring blade 44 which is driven by the motor 42. The motor 42 and the stirring blade 44 are connected through a detachable connection between a driving axle 422 of the motor 42 and a stirring axle 442 of the stirring blade 44. To this end, the driving axle 422 may be formed with a rectangular axle hole 422a. An end of the stirring axle 442 having a rectangular cross section may be detachably inserted into the axle hole 422a, which is shown in FIG. 1. The stirring blade 44 extends from the stirring axle 442 through the circular open portion in the top of the housing 10 toward the interior surface of the heat conductive container 60, and the other end of the stirring axle 442 is rotatably mounted in the indentation 61 which may be formed on the inside bottom surface of the heat conductive container 60.

The stirring unit 40 includes a cap 47 which may be integrally connected to a lower portion of the motor 42. The cap 47 is fitted into the open portion in the upside of the housing 10 described above to allow the stirring unit 40 to be detachably installed to the housing 10, for example. When the frozen yogurt or the fermented and/or ripened yogurt is completely made, the stirring unit 40 may be separated from the housing 10, such that a user can obtain the yogurt in the container 60, such as by removing the container 60.

The apparatus 1 for making frozen yogurt shown in FIG. 1 may have a structure in which the motor 42 integrated with the cap 47 is completely separated from the housing 10 Alternatively, the motor 42 integrated with the cap 47 may be hinged to the housing 10, as illustrated in FIG. 6, for example. Referring to FIG. 6, a hinge piece 71 connected to one side of the motor 42 is received and maintained in a hinge supporting portion 17 on the top of the housing 10. A hinge guide 17a provided in the hinge supporting portion 17 may allow the hinge piece 71 to linearly and pivotally move, allowing the motor 42 and the cap 47 connected thereto to be linearly moved before they are pivotally opened from the housing 10, so that the stirring axle 442 of the stirring blade 44 can be prevented from impinging on the container 60.

As shown in FIGS. 1 and 2, the apparatus 1 for making frozen yogurt according to this embodiment may include a safety switch 80 for power in the motor 42 when the motor 42 is separated from the top of the housing 10. The safety switch 80 is configured to forcibly switch off power in the motor 42 when the motor 42 is not mounted to the housing 10 even if an external power supply plug (not shown) has been connected to an electric linkage port (outlet) 19. To this end, the safety switch 80 includes a switch bar 82, which is moved downward when the motor 42 is mounted to the housing 10, and an electric contact portion 84, which is provided in the housing 10 so as to be pushed by the switch bar 82.

The safety switch 80 allows the motor 42 to be driven only if the motor 42 and the cap 47 connected thereto rest accurately onto the operational position in the housing 10, so that the motor 42 can be prevented from being driven while the motor 42 is not in its operation position avoiding accidents which might be caused by such driving of the motor 42, when not properly mounted.

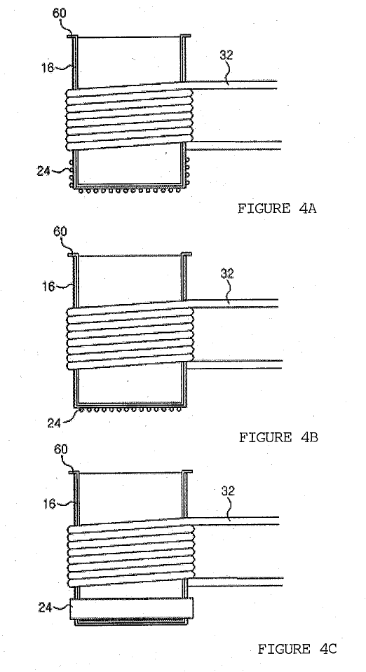

An arrangement and structure of the refrigerant pipe 32 and the heating element 24 is thoroughly considered. The refrigerant pipe 32 and the heating element 24, which are in contact with the heat conductive cup 16 and/or the container 60 transfer heat to the refrigerating unit and from the heating unit to the ingredients in the container. FIGS. 4(a) to (c) and 5(a) to (d) show alternative arrangements of the refrigerant pipe 32 and the heating element 24.

FIGS. 4(a) and (b) show examples in which both the refrigerant pipe 32 and the heating element 24 are in contact with the external peripheral surface of the heat conductive cup 16. In these examples, the refrigerant pipe 32 is wound in the form of a coil around the external peripheral surface of the heat conductive cup 16, while the heating element 24, which is in the form of a hot wire, may be in contact with both the external peripheral surface and the bottom surface of the heat conductive cup 16 (FIG. 4(a)) or only the bottom surface of the heat conductive cup 16 (FIG. 4(b)). Further, the heating element 24 in the form of not a hot wire but a band (FIG. 4(c)) or plane (not shown) may be in contact with the external peripheral surface and/or bottom surface of the heat conductive cup 16. A thermoelectric element may be used as the heating element 24 instead of the hot wire type heating element, the plane shaped heating element, or the band type heating element, as an alternative.

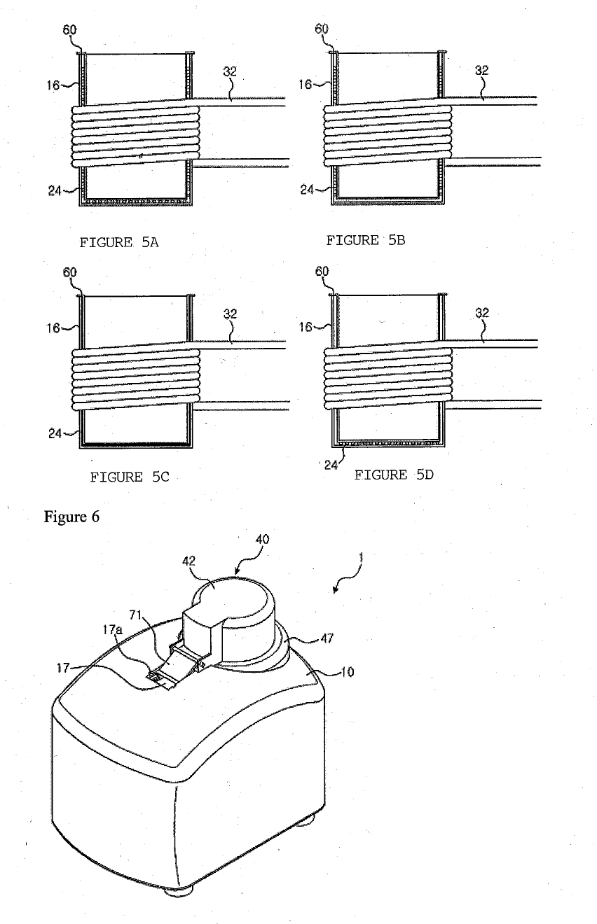

FIGS. 5(a) to (d) show examples in which the heating element 24 is installed on an internal surface of a heat conductive cup 16 and faces the heat conductive container 60 positioned therein. Referring to FIGS. 5A-5D, the heating element 24 in the form of a hot wire may be installed on the internal peripheral surface and/or inside bottom surface of the heat conductive cup 16 (FIGS. 5(a), (b) and (d)), or the heating element in the form of a plane may be installed on the inside surface of the heat conductive cup 16. Although not shown, a thermoelectric element may be used, as the heating element, instead of the aforementioned heating elements, installed on an inside surface of a heat conductive cup 16.

The heating elements 24 shown in FIGS. 5A-5D are preferable, because thermal interference between the refrigerant pipe 32 and the heating element 24 is lessened, reducing any adverse effect of the heating of the heating element 24 on the refrigerant.

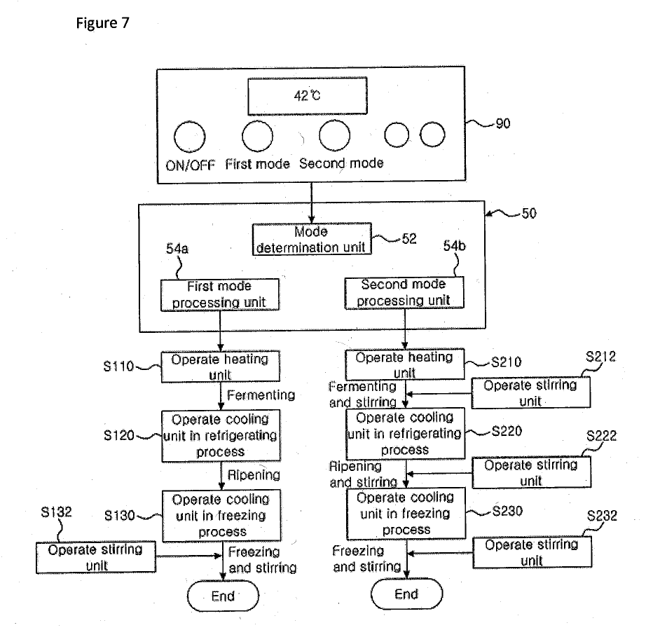

FIG. 7 is a schematic block diagram illustrating a method of control using an apparatus for making frozen yogurt. Hereinafter, the method will be described with reference to the examples of FIGS. 1 to 7, specifically the example illustrated in FIG. 7. The control unit 50, as illustrated in FIG. 3, for example, includes a mode determination unit 52 for determining a process mode for the yogurt ingredients, and a plurality of mode processing units 54a and 54b, embodied in hardware, software or firmware, for selectively controlling the heating unit 20, the cooling unit 30 and the stirring unit 40, based on a mode of operation selected using the mode determination unit 52. The mode determination unit 52 determines the process mode of the yogurt ingredients based on a selection input signal from a menu board 90 such as by a button or buttons provided on the outside surface of the housing 10.

A first mode processing unit 54a controls process for making frozen yogurt. If the mode determination unit 52 determines to perform the first mode is invoked, the first mode processing unit 54a controls the operational units 20, 30 and 40 according to the following steps, for example. First, the heating unit 20 is operated to ferment yogurt ingredients inserted into the heat conductive container 60 at a temperature in a range of 36 to 42° C., preferably 40 to 42° C., for about 6 to 10 hours, preferably about 8 hours for example. When a gelled, fermented yogurt is obtained, (S110) the operational units 30, 40 and 50 maintain their standby states except for the heating unit 20, which continues until fermentation is complete. Then, the cooling unit 30 turns on to provide refrigeration at a temperature of about 2 to 5° C. for 20 minutes to one hour (S120), while the heating unit 20 is turned off. Although not shown in detail, control of the refrigeration temperature may be achieved using a temperature sensor and a temperature control means for controlling the temperature in the container based on sensing of the output of the temperature sensor as is known in the art of refrigeration. The refrigeration operation of the cooling unit 30 causes the fermented yogurt ingredients in the container 60 to be refrigeration-ripened, for example, Through this ripening process, the yogurt ingredients may undergo additional gelation. When the refrigeration-ripening process is completed, the cooling unit 30 may be operated to reduce the temperature to a freezing temperature of about −20° C. (S130), for example. During such a freezing process, the stirring unit 40 is operated under control of the control unit to stir the gelled, fermented yogurt ingredients (S132), making a frozen yogurt. For example, the yogurt ingredients input at the start of the process may be milk with lactobacilli added or milk with a small quantity of a ready-made yogurt with active cultures mixed into the ready-made yogurt.

A second mode processing unit 54b may perform a process for making a yogurt sherbet based on a determination of the mode determination unit 52. The heating unit 20 may be operated under the same condition as described in the first mode to ferment yogurt ingredients in the container (S210); however, a stirring unit 40 is operated to intermittently stir the yogurt ingredients, in order to prevent the fermented yogurt ingredients from cohesively gelling. A liquidized fermented yogurt (S212) is obtained upon completion of fermentation. Then, the cooling unit 30 is operated under the same condition as described in the first mode to refrigeration-ripen the fermented yogurt (S220), except that the stirring unit 40 may stir the yogurt (S222) during the refrigeration-ripening process or stirring may be omitted if liquefaction of the yogurt has been sufficiently achieved due to the stirring step in the preceding fermenting process. The cooling unit 30 may be chilled under the same condition as described in the first mode (S230). Simultaneously, it is preferable that the stirring unit 40 stir the yogurt during its freezing process (S232), thereby making yogurt sherbet instead of frozen yogurt with the consistency of ice cream, which is made creamier by gelation of the yogurt prior to the freezing process.

The control unit 50 may perform another mode in which the freezing and stirring steps of the yogurt ingredients (S130 and S123; and S230 and S232) are omitted. These modes may be used either to ferment and refrigeration-ripen yogurt ingredients, without stirring or freezing them to obtain a gelled refrigerating plain yogurt or to ferment and refrigeration-ripen yogurt ingredients, while stirring but not freezing them, to obtain liquidized yogurt drink.

The control unit 50 may include a control mode in which the heating unit 20, the cooling unit 30 and the stirring unit 40 are separately used or another control mode in which only the cooling unit 30 and the stirring unit 40 are used with the operation of the heating unit 20 omitted. Specifically, the freezing operation of the cooling unit 30 and the stirring operation of the stirring unit 40 may be used to make an ice cream or sherbet with no step of fermenting. Likewise, a step of “cooking” may be added to create a frozen custard, with or without an intermediate step of ripening at a reduced temperature.

Although the present invention has been described with reference to the preferred embodiments, it will be apparent in the art that various modifications, changes, alterations can be made within the spirit of the present invention and the appended claims. Therefore, the aforementioned descriptions and drawings should be interpreted as not the limitation of the present invention but the illustrations thereof.

What is claimed is:

1. An apparatus for making frozen yogurt and other products, comprising:
a housing;
a heat conductive container for receiving yogurt ingredients;
a heating unit installed in the housing and provided with a heating element for heating the container;
a cooling unit installed in the housing and provided with a refrigerant pipe for cooling the container by a refrigeration cycle caused by supplying electric power;
a stirring unit provided with a stirring blade, the stirring blade being rotated in the container by a motor; and
a control unit electrically coupled to the heating unit, the cooling unit and the stirring unit capable of making frozen yogurt from yogurt ingredients.

2. The apparatus of claim 1, further comprising a heat conductive cup fixed and installed to the housing to detachably receive the heat conductive container, wherein the refrigerant pipe is wound in the form of a coil around an external peripheral surface of the heat conductive cup.

3. The apparatus of claim 2, wherein the heating element is arranged in contact with an external bottom surface of the heat conductive cup or an external peripheral surface of the heat conductive cup at a distance from the refrigerant pipe.

4. The apparatus of claim 2, wherein the heating element fixed to an interior surface of the heat conductive cup such that the heating element faces the heat conductive container.

5. The apparatuses of claim 3, wherein the heating element includes a hot wire type heating element, a band type heating element, a plane shaped heating element, a thermoelectric element or a combination thereof.

6. The apparatus of claim 1, wherein the motor detachably rests on the housing, an axle of the motor is detachably coupled to one end of an axle of the stirring blade, and an opposite end of the axle of the stirring blade is rotatably maintained in a recess formed on an inside bottom surface of the container.

7. The apparatus as claimed in claim 6, further comprising a safety switch for forcibly switching off power in the motor when the motor is separated from a top portion of the housing.

8. The apparatus as claimed in claim 1, wherein the control unit electronically controls the stirring unit to selectively drive the stirring unit during a fermenting process inducing operating of the beating unit.

9. The apparatus as claimed in claim 1, wherein the control unit electronically controls the stirring unit to selectively drive the stirring unit during a freezing process including operating of the heating unit.

10. The apparatus as claimed in claim 1, wherein the control unit electronically controls the cooling unit during a refrigeration-ripening process including operating the cooling unit.

11. The apparatus as claimed in claim 2, wherein the cup, the heating element, and the container are arranged such that a fermentation temperature in the container is controlled by the control unit in a range of 40 to 42° C. by operating the heating unit at a temperature not to exceed 60° C.

12. A method for controlling an apparatus of claim 1, comprising the steps of:
heating ingredients in the container of the apparatus of claim to obtain a fermented yogurt using the heating unit under the control of the control unit; and
freezing the fermented yogurt in the same container as used in the step of heating without removing the fermented yogurt and using the cooling unit under the control of the control unit.

13. The method of claim 12, further comprising a step of refrigeration-ripening the fermented yogurt for a predetermined period of time using the cooling unit in a different temperature range than during the step of freezing, before the step of freezing.

14. The method of claim 12, further comprising: a step of stirring the yogurt ingredients using the stirring unit during the step of heating.

15. The method of claim 12, further comprising: a step of stirring the fermented yogurt during the step of freezing the fermented yogurt using the stirring unit.

16. The method of claim 12, wherein the step of heating maintains a fermentation temperature of the yogurt in a range of 40 to 42° C.

17. The method of claim 16, wherein the step of heating maintains a heating temperature of the heating unit no greater than 60° C.
